(19) United States
(12) Patent Application Publication
(10) Pub. No.: US 2008/0081135 A1
(43) Pub. Date: Apr. 3, 2008

(54) Container

(75) Inventor: Robert M. Spurrell, Kent, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/537,430

(22) Filed: Sep. 29, 2006

(51) Int. Cl. B32B 27/10; B32B 3/30

(52) U.S. Cl. 428/34.2; 428/182

(57) ABSTRACT

A container (10) generally includes a cellulose-based sheet (22) having a corrugated medium (24) spanning between first and second linerboards (26 and 28) and a fluid-resistant barrier (36) attached to one of the first and second linerboards. The container further includes at least one cutout (30) extending through the sheet and a covering (32) spanning a periphery (34) of the at least one cutout.

### TECHNICAL FIELD

Embodiments of the present disclosure relate generally to containers and, more specifically, to fluid-resistant containers having covered cutouts.

### SUMMARY

This summary is provided to introduce a selection of concepts in a simplified form that are further described below in the detailed description. This summary is not intended to identify key features of the claimed subject matter, nor is it intended to be used as an aid in determining the scope of the claimed subject matter.

In accordance with one embodiment of the present disclosure, a container is provided. The container includes a cellulose-based sheet having a corrugated medium spanning between first and second linerboards and a fluid-resistant barrier attached to one of the first and second linerboards. The container further includes at least one cutout extending through the sheet and a covering spanning a periphery of the at least one cutout.

In accordance with another embodiment of the present disclosure, a container blank is provided. The container blank includes a cellulose-based sheet having a corrugated medium spanning between first and second linerboards and a fluid-resistant barrier attached to one of the first and second linerboards. The container blank further includes at least one cutout extending through the sheet and a covering spanning a periphery of the at least one cutout.

In accordance with still other embodiments of the present disclosure, the fluid-resistant barrier is adjacent one of the first and second linerboards and the polymeric film is attached to the fluid-resistant barrier.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is a perspective view of a fluid-resistant container having a covered cutout formed according to various aspects of the present disclosure;

FIG. 2 is a perspective view of a container blank used to form the container of FIG. 1;

FIG. 3 is a cross-sectional view of a wall of the container of FIG. 1;

FIGS. 4 and 5 are alternate embodiments of a wall of the container of FIG. 1.

### DETAILED DESCRIPTION

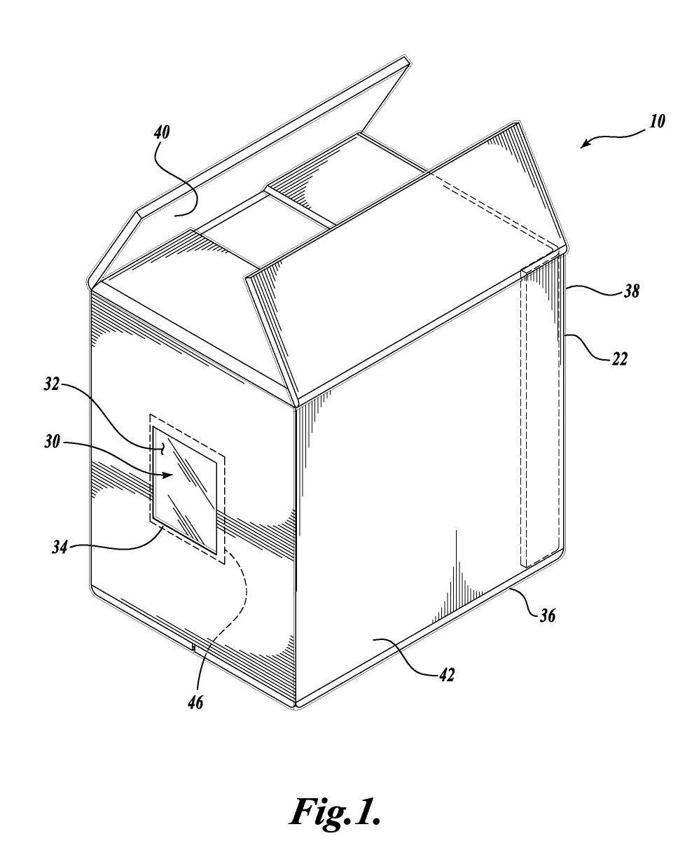

Embodiments of the present disclosure are generally directed to corrugated cellulose-based containers and container blanks having fluid-resistant barriers and covered openings. A fluid-resistant container 10 constructed in accordance with one embodiment of the present disclosure may be best understood by referring to FIGS. 1-3. The container 10 is suitably formed from a cellulose-based sheet 22 having a corrugated medium 24 spanning between the first and second linerboards 26 and 28 and a fluid-resistant barrier 36 attached to the one of the first and second linerboards 26 and 28. The container further includes at least one cutout 30 extending through the sheet 22 and a covering 32, such as a polymeric film, spanning a periphery 34 of the at least one cutout 30.

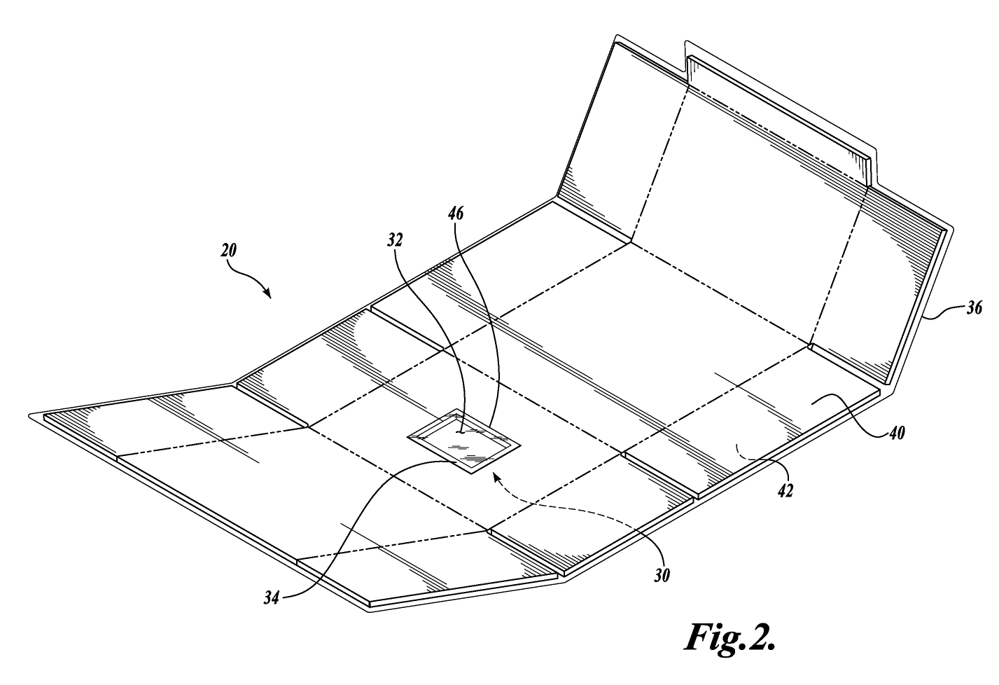

A container blank 20 for the container 10 of FIG. 1 is best seen in FIG. 2. Because the container 10 of FIG. 1 and the container blank 20 of FIG. 2 are the same article, but merely in different orientations (box orientation and flat orientation, respectively), it should be appreciated that the terms container 10 and container blank 20 can be used interchangeably throughout the present disclosure.

The container blank 20 includes panels that form the sidewalls and end walls of an assembled container 10. As illustrated, the container blank 20 has a first surface 40 and a second opposite surface 42. When constructed as the container 10 of FIG. 1, the first surface 40 is suitably the inner surface of the container 10 and the second surface 42 is the outer surface of the container 10.

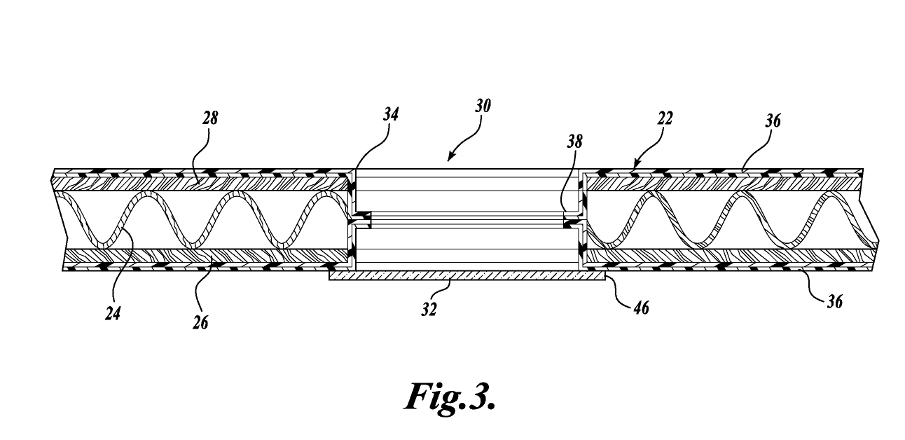

As mentioned above, the container 10 and container blank 20 are generally manufactured from a cellulose-based sheet 22. It should be appreciated that cellulose-based sheets are formed from cellulose materials such as wood pulp, straw, cotton, bagasse and the like. As seen in FIG. 3, the cellulose-base sheet 22 includes a first linerboard 26, a second linerboard 28, and a corrugated medium or flutes 24 spanning between the first and second linerboards 26 and 28. As will be described in detail below, the sheet 22 includes a fluid-resistant barrier 36 attached to at least one of the first and second linerboards 26 and 28.

It should be appreciated that the following linerboards are within the scope of the present disclosure: fibreboard, containerboard, corrugated containerboard and paperboard. Depending on the application for the container, the walls of the container may be constructed from multiple layers of cellulose-based sheets, or may include multiple layers of linerboard (i.e., more than two linerboards) and multiple corrugated mediums (i.e., more than one corrugated medium). Exemplary thicknesses for the cellulose-based sheet 22 are between about 5 and 30 mil, or more preferably, between about 7 and 25 mil.

The container 10 is fluid resistant or fluid impervious. The term fluid resistant as used herein describes a resistance and or imperviousness to fluids, including water (such as water or moisture from contained products) and gases (such as air), whether such fluids are traveling into or out of the container. As may be best seen by referring to FIG. 3, the container 10 (FIG. 1) is suitably encapsulated in an encapsulating film 36 in accordance with the encapsulation methods described in U.S. patent applications Ser. Nos. 10/880,008, 10/879,268, and 10/879,821, as referenced above. As described in these referenced applications, the edges 38 of the container encapsulated in the encapsulating film 36 may be sealed to each other to further enhance the fluid-resistant properties of the container.

The encapsulating polymeric films can be trimmed around the edges 38 of the container at the cutout 30. The trimming at the cutout 30 provides an opening through the container over which the covering 32 can span. While multiple overlapping layers of encapsulating films generally provide a blurred window, the covering 32 used to cover the cutout 30 contemplated by the present disclosure provides clear windows for their intended purpose, viewing the interior compartment of the container.

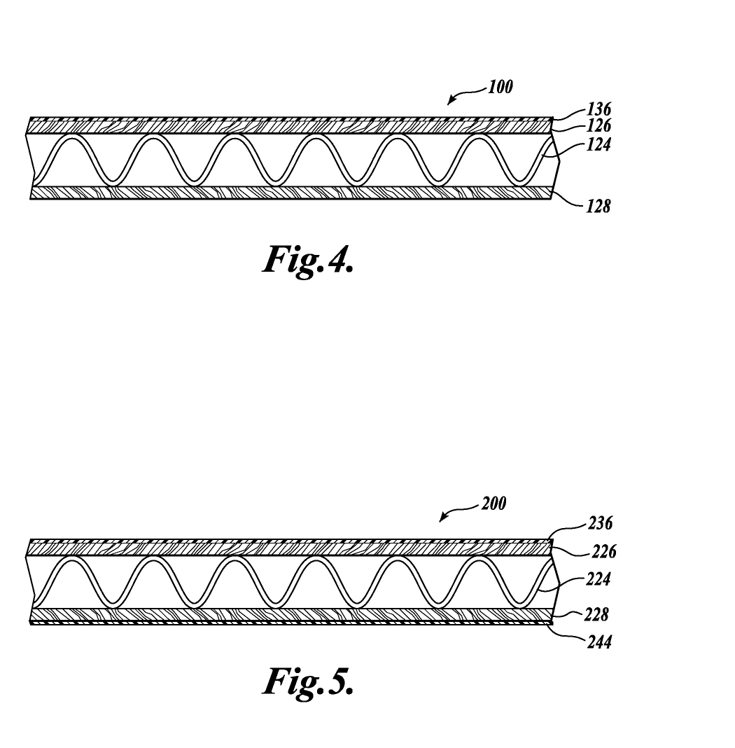

As an alternate embodiment, instead of encapsulation for fluid resistance, the cellulose-based sheet may merely include a fluid-resistant barrier as part of its multilayer construction. Referring to FIG. 4, an example of a partial cross-sectional of a sheet 100 of a container 10 (FIG. 1) having a fluid-resistant barrier 136 is shown. The sheet 100 of FIG. 4 includes a cellulose-based sheet having first and second linerboards 126 and 128 with a corrugated medium 124 disposed between the first and second linerboards 126 and 128. The fluid-resistant barrier 136 is adjacent the first linerboard 126. In this construction, the fluid-resistant barrier 136 is attached to the first linerboard 126 in accordance with methods known and used in the art.

Regarding the example illustrated in FIG. 4, it should be appreciated that the container may be constructed (for example, from a blank) to locate the fluid-resistant barrier 136 on either the inner or outer surface 40 or 42 of the container 10 (FIG. 1). For example, if an expected source of fluid or moisture is from within the container, such as from ice packing within the container, the fluid-resistant barrier 136 can be located on the inner surface 40 of the container 10. If an expected source of fluid or moisture is from outside the container, such as from weather when the container is on an open-bed truck, the fluid-resistant barrier 136 can be located on the outer surface 42 of the container 10.

In addition, the container may include more than one fluid-resistant barrier. This may be best understood by referring to FIG. 5. As seen in FIG. 5, the sheet 200 may include a second fluid-resistant barrier 244 adjacent or attached to the second linerboard 228.

With reference to FIGS. 4 and 5, it should be appreciated that fluid-resistant barriers 136, 236, and 244 may be attached to sheets 100 and 200, not on the entire container, but on only a portion of the sheets 100 and 200 that make up the container. As a non-limiting example, the fluid-resistant barrier 136 may be attached to sheet 100 only around the periphery of the cutout (not shown) to provide fluid resistance at the cutout, but not at other areas of the container.

Returning to FIGS. 1-3, the cutout 30 extends through the cellulose-based sheet 22. Although the cutout 30 is rectangular in shape in the illustrated embodiment, it should be appreciated that a cutout of any shape is within the scope of the present disclosure. It should also be appreciated that the cutout 30 may be located on any sidewall or end wall of the container 10. As a non-limiting example, the cutout 30 may be die-cut or cut by any other suitable method for removing a cutout 30 from the cellulose-based sheet 22.

As seen in FIG. 3, the fluid-resistant barrier 36 of the sheet 22 is overlaid with the covering 32 such that the covering spans the periphery 34 of the cutout 30. In that regard, the fluid resistant barrier 36 and the covering 32 are bondable to one another. In the illustrated embodiment of FIG. 3, the outer edge 46 of the covering 32 overlaps with the fluid-resistant barrier 36 such that the covering 32 may be adhered, heat sealed, or otherwise attached to the fluid-resistant barrier 36 by any method known and used in the art. In this construction, the covering 32 can be attached to the fluid-resistant barrier 36 of the sheet 22 after the cutout 30 is removed from the sheet 22. In the example described above, wherein the fluid-resistant barrier is attached to only the portion of the sheet around the periphery of the cutout, the cover would still be attachable to the fluid-resistant barrier at the overlap of the outer edge of the covering and fluid-resistant barrier.

It should be appreciated that in other embodiments of the present disclosure, the covering 32 also may span the periphery 34 of the cutout 30 by attaching to the fluid-resistant barrier 36 on the first linerboard 26. It should also be appreciated that more than one covering 32 overlaying the cutout 30, e.g., on both fluid-resistant barriers 36 attached to both first and second linerboards 26 and 28, is also within the scope of the present disclosure. The covering 32, when overlaid on the cellulose-based sheet 22, provides a window for viewing into (or out of) the interior compartment of the container 10.

As discussed in detail below, coverings 32 in accordance with the present disclosure include films that are fluid resistant and/or fluid impervious. As non-limiting examples, the covering 32 may include, but is not limited to, one or more of the following films: low-density polyethylene, high-density polyethylene, linear low-density polypropylene, ethylene vinyl acetate, ionomer, oriented polyethylene, oriented polypropylene, polyvinyl chloride, polystyrene, polyvinylidene chloride, biaxially oriented nylon, cellophane, and any other films known to one of ordinary skill in the art that are fluid resistant and readily adhere-able or attachable to a cellulose-based sheet. Preferably, such materials are readily attachable to a fluid-resistant barrier of the cellulose-based sheet, as described in greater detail below.

The choice of a specific covering composition and structure will depend on the ultimate needs of the particular application for the cellulose-based sheet. Coverings should be chosen so that they provide the proper balance between properties, such as clarity flexibility, fluid resistance, abrasion-resistance, tear-resistance, slip-resistance, color, printability and toughness. Graphics may be preprinted on the covering. In addition, for food applications, the material used to form the covering 32 is preferably approved for use by the U.S. Food and Drug Administration.

The covering 32 may be a multilayer film, e.g., a two or more layer film. Some multilayer films have improved abrasion resistance, as well as barrier, adhesion, and antistatic properties. Multilayer films having layers with different melting points are also within the scope of the disclosure, such that the layer of film adjacent the linerboard 26 or 28 has a melting point that is lower than the melting point of the layer that is not directly adjacent the linerboard 26 or 28. For example, a two-layer covering, wherein the layers of the covering have a melting point difference of at least 14° C.-17° C. (25° F.-30° F.) are within the scope of the present disclosure. One such example is a covering that is a co-extruded film having an outer layer of linear low-density polyethylene with a melting point of about 130° C. (266° F.) and an inner ethylene vinyl acetate bonding layer with a melting point of about 80° C. (176° F.).

Other examples of suitable coverings include co-extruded films, for example, that include layers of linear low-density polyethylene, ethylene acrylic acid, and ethylene methacrylic acid. Other examples of films used as coverings include layers of metallocene, SURLYN® thermoplastic resins from DuPont Company, polypropylene, polyvinylchloride, or polyesters or combinations thereof.

It should be appreciated that the films can be metallized to alter their electrical characteristics or reduce their fluid permeability. In addition, tie layers which bond two or more layers of a multilayer film together by being bondable with both adjacent layers are also within the scope of the disclosure.

The thickness of the covering 32 can vary over a wide range. It is preferred that the covering 32 should not be so thick that when it is applied to a container 10 and heated it will not conform to changes in topography along the surface of the container 10 at the peripheral edges of the cutout 30. However, the covering 32 should be thick enough to survive normal use conditions without losing its fluid resistance. Exemplary film thicknesses range from about 0.7 mil (approximately 0.018 mm) to about 4.0 mil (approximately 0.10 mm).

The covering 32 is attached to the fluid-resistant barrier 36 at the periphery 34 of the cutout 30 by any suitable attachment method. As a non-limiting example, the covering 32 is attachable to the barrier 36 by a fluid resistant or fluid impervious attachment method, such that fluid does not enter the container 10 via the covering 32. Exemplary methods of attaching the covering 32 to the fluid-resistant barrier 36 of the sheet 22 include heat and pressure, sonic activation, as well as other activation methods known and used in the art. Other suitable methods of attaching the covering 32 to the fluid-resistant barrier 36 of the sheet 22 include nonelectromagnetic heating, electromagnetic radiation heating, and adhesive, as described, respectively, in U.S. patent applications Ser. Nos. 10/880,008, 10/879,268, and 10/879,821, the disclosures of which are hereby expressly incorporated by reference.

While illustrative embodiments have been illustrated and described, it will be appreciated that various changes can be made therein without departing from the spirit and scope of the disclosure.

The embodiments of the disclosure in which an exclusive property or privilege is claimed are defined as follows:

1. A container, comprising:
(a) a cellulose-based sheet having a corrugated medium spanning between first and second linerboards and a fluid-resistant barrier attached to one of the first and second linerboards;
(b) at least one cutout extending through the sheet; and
(c) a covering spanning a periphery of the at least one cutout.

2. The container of claim 1, wherein the covering is a polymeric film.

3. The container of claim 1, wherein the covering is adhered to the cellulose-based sheet around the periphery of the at least one cutout.

4. The container of claim 1, wherein the covering is sealed to the cellulose-based sheet around the periphery of the at least one cutout.

5. The container of claim 1, wherein the covering is heat-sealed to the cellulose-based sheet around the periphery of the at least one cutout.

6. The container of claim 1, wherein the covering includes at least one of low-density polyethylene, high-density polyethylene, linear low-density polypropylene, ethylene vinyl acetate, ionomer, oriented polyethylene, oriented polypropylene, polyvinyl chloride, polystyrene, polyvinylidene chloride, biaxially oriented nylon, and cellophane.

7. The container of claim 1, wherein the covering is adjacent one of the first and second linerboards.

8. The container of claim 1, wherein the fluid-resistant barrier is adjacent at least one of the first and second linerboards.

9. The container of claim 1, wherein the fluid-resistant barrier is adhered to at least one of the first and second linerboards.

10. The container of claim 1, wherein the fluid-resistant barrier is heat-sealed to at least one of the first and second linerboards.

11. The container of claim 1, wherein the fluid-resistant barrier encapsulates the cellulose-based sheet.

12. The container of claim 1, wherein the fluid-resistant barrier includes at least one of low-density polyethylene, high-density polyethylene, linear low-density polypropylene, ethylene vinyl acetate, ionomer, oriented polyethylene, oriented polypropylene, polyvinyl chloride, polystyrene, polyvinylidene chloride, biaxially oriented nylon, and cellophane.

13. A container blank, comprising:
(a) a cellulose-based sheet having a corrugated medium spanning between first and second linerboards and a fluid-resistant barrier attached to one of the first and second linerboards;
(b) at least one cutout extending through the sheet; and
(c) a covering spanning a periphery of the at least one cutout.

14. The container blank of claim 13, wherein the covering is a polymeric film.

15. The container blank of claim 13, wherein the covering is attached to the fluid-resistant barrier.

16. The container blank of claim 13, wherein the covering is sealed to the fluid-resistant barrier.

17. The container blank of claim 13, wherein the covering is heat-sealed to the fluid-resistant barrier.

18. A container, comprising:
(a) a cellulose-based sheet having a corrugated medium spanning between first and second linerboards and a fluid-resistant barrier adjacent one of the first and second linerboards,
(b) at least one cutout extending through the sheet; and
(c) a polymeric film spanning a periphery of the at least one cutout, wherein the polymeric film is attached to the fluid-resistant barrier.
